(19) United States
(12) Patent Application Publication
(10) Pub. No.: US 2025/0321532 A1
(43) Pub. Date: Oct. 16, 2025

(54) IMAGE FORMING APPARATUS

(71) Applicant: CANON KABUSHIKI KAISHA, Tokyo (JP)

(72) Inventor: KOHEI MIZUGUCHI, Ibaraki (JP)

(21) Appl. No.: 19/082,647

(22) Filed: Mar. 18, 2025

(30) Foreign Application Priority Data
Apr. 15, 2024 (JP) 2024-065340

(51) Int. Cl. G03G 21/16

(52) U.S. Cl. CPC G03G 21/1638; G03G 21/1647

(57) ABSTRACT

An image forming apparatus according to the present invention includes: an opening and closing member rotatably supported by an image forming apparatus main body; a connecting member; a support member being configured to move in a first direction in conjunction with an operation of opening the opening and closing member; a restricting member configured to be movable to a restricting position at which the support member to restrict movement of the support member in the first direction and a retracted position at which the restricting position to allow movement of the support member in the first direction; and a switching member configured to be switched between a support position where the restricting member to support the restricting member at the restricting position, and a release position where the restricting member to allow the movement of the restricting member to the retracted position.

### BACKGROUND OF THE INVENTION

### Field of the Invention

The present invention relates to an image forming apparatus such as a printer, a facsimile, a copying machine, or a multifunction peripheral having these functions.

### Description of the Related Art

Conventionally, in an image forming apparatus, a configuration in which an opening and closing member openably and closably supported by an apparatus main body is brought into an open state to expose the inside of the apparatus and jam recovery with respect to a sheet remaining inside the apparatus, replacement of a unit, or the like is performed is known.

In the image forming apparatus described in Japanese Patent Application Laid-Open No. 2019-53100, regarding the opening position of the opening and closing member, two stages of opening positions are provided, where a position where jam recovery is performed is a first opening position, and a position where unit replacement is performed is a second opening position. The opening position of the opening and closing member is determined to be the first opening position by restricting by a first restricting member. In order to move the opening and closing member from the first opening position to the second opening position, the opening and closing member is moved to a retracted position by operating and rotating the first restricting member.

However, in Japanese Patent Application Laid-Open No. 2019-53100, since the rotation direction of the first restricting member faces the load direction due to the weight of the opening and closing member, the first restricting member cannot be moved to the retracted position unless the first restricting member is operated with an operating force that overcomes the weight of the opening and closing member. In addition, the opening and closing member includes many components such as a conveyance guide, a roller, and a frame, and its own weight is not at all light, making it difficult to operate the first restricting member alone.

Therefore, the operator needs to perform an operation of supporting the weight of the opening and closing member in order to reduce a load acting on the first restricting member and perform an operation of moving the first restricting member to the retracted position. That is, when the opening position of the opening and closing member is switched, the operator needs to simultaneously perform two operations.

### SUMMARY OF THE INVENTION

A representative configuration of the present invention includes: an opening and closing member rotatably supported by an image forming apparatus main body and configured to open and close with respect to the image forming apparatus main body by being rotated; a connecting member having one end portion supported by the image forming apparatus main body and the other end portion supported by the opening and closing member; a support member configured to support the other end portion of the connecting member, the support member being configured to move in a first direction in conjunction with an operation of opening the opening and closing member; a restricting member configured to be movable to a restricting position at which the restricting member is brought into contact with the support member to restrict movement of the support member in the first direction and a retracted position at which the support member is retracted from the restricting position to allow movement of the support member in the first direction, the restricting member being configured to restrict movement of the support member in the first direction to maintain the opening and closing member at an opening position; and a switching member configured to be switched between a support position where the switching member is brought into contact with the restricting member to support the restricting member at the restricting position, and a release position where the switching member releases the contact with the restricting member to allow the movement of the restricting member to the retracted position.

Further features of the present invention will become apparent from the following description of exemplary embodiments with reference to the attached drawings.

### BRIEF DESCRIPTION OF THE DRAWINGS

FIG. 1 is a cross-sectional view of an image forming apparatus.

FIG. 2 is a cross-sectional view when an opening and closing member is at a closed position.

FIG. 3 is a cross-sectional view when the opening and closing member is at a first restricting position.

FIG. 4 is a cross-sectional view when the opening and closing member is at a second restricting position.

FIG. 5 is a view of a state in which a support member is supported at the first restricting position.

FIG. 6 is a view illustrating a state in which a switching member is operated at the first restricting position.

FIG. 7 is a view illustrating a state in which the first restricting member is retracted at the first restricting position.

FIG. 8 is a view illustrating a state in which the support member moves from the first restricting position to the second restricting position.

FIG. 9 is a view of the opening and closing member as viewed from the inside of the apparatus main body.

FIG. 10 is a view of a state in which the operation member stands by at the first restricting position.

FIG. 11 is a view of a state in which the operation member is operated at the first restricting position.

FIG. 12 is a view of the front support member in a state where the opening and closing member is closed.

FIG. 13 is a view of the front support member when the opening and closing member is at the first restricting position.

FIG. 14 is a view of the front support member when the opening and closing member is at the second restricting position.

### DESCRIPTION OF THE EMBODIMENTS

Hereinafter, embodiments of the present invention will be exemplarily described in detail with reference to the drawings. However, the dimensions, materials, shapes, relative arrangements, and the like of the components described in the following embodiments are not intended to limit the scope of the present invention only to them unless otherwise specified.

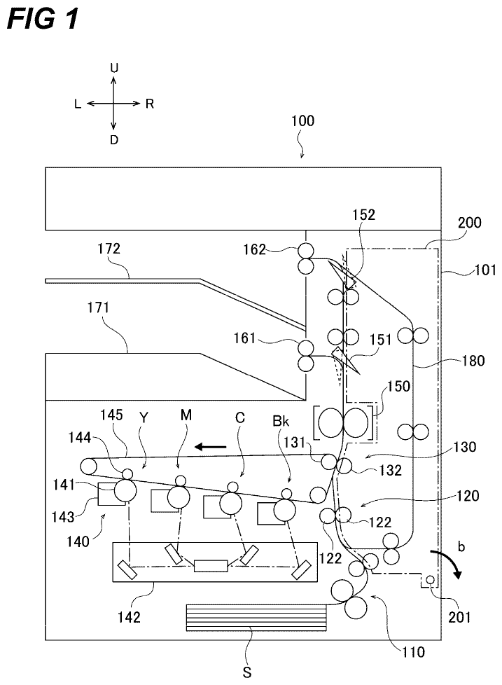

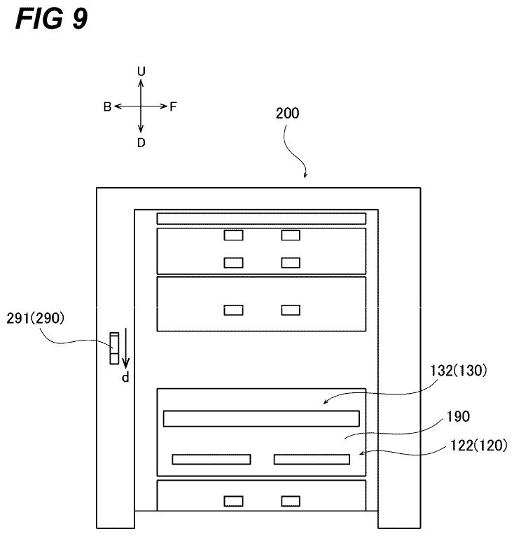

In the following description, an upward direction U, a downward direction D, a rightward direction R, a leftward direction L, a backward direction B, and a forward direction F illustrated in FIGS. 1 and 9 are defined as follows. A direction from behind to in front of the sheet surface of FIG. 1 (a direction from the left to the right of the sheet surface of FIG. 9) is referred to as a forward direction F, and a direction from the front to the back of the sheet surface of FIG. 1 (a direction from the right to the left of the sheet surface of FIG. 9) is referred to as a backward direction B. In FIG. 1, when an image forming portion that forms a black Bk image is used as a reference, a side on which an image forming portion that forms a yellow Y image is disposed is defined as a left side, and a direction toward the left side is defined as a leftward direction L. When an image forming portion that forms a yellow Y image is used as a reference, a side on which an image forming portion that forms a black Bk image is disposed is defined as a right side, and a direction toward the right side is defined as a rightward direction R. Furthermore, a direction perpendicular to the front-back direction and the left-right direction defined here and upward in the vertical direction is defined as an upward direction U, and a direction perpendicular to the front-back direction and the left-right direction defined here and downward in the vertical direction is defined as a downward direction D.

### (Image Forming Apparatus)

A schematic configuration of an image forming apparatus will be described with reference to FIG. 1. FIG. 1 is a cross-sectional view of an image forming apparatus. The image forming apparatus 100 illustrated in FIG. 1 is an intermediate transfer tandem type image forming apparatus in which image forming portions 140 of four colors of yellow Y, magenta M, cyan C, and black Bk are arranged side by side on an intermediate transfer belt 145.

In the following description, Y, M, C, and Bk are added as suffixes to the members using the toners of the respective colors, but the configurations and operations of the members are substantially the same except that the colors of the toners to be used are different, and thus the suffixes are appropriately omitted unless distinction is required.

A sheet S is stacked and stored in a storage portion such as a cassette disposed in a lower portion of the image forming apparatus. The sheets S stored in the storage portion are fed one by one by a sheet feeding portion 110. The sheet S fed by the sheet feeding portion 110 is conveyed to a registration roller pair 120. The sheet S is sent to a secondary transfer portion 130 after skew feeding correction and timing correction are performed in the registration roller pair 120. The secondary transfer portion 130 is formed by a secondary transfer inner roller 131 and a secondary transfer outer roller 132 facing each other with the intermediate transfer belt 145 interposed therebetween. The secondary transfer portion 130 transfers a toner image formed on the intermediate transfer belt 145 to the sheet S by applying a predetermined pressure and electrostatic load bias while nipping and conveying the sheet S.

A process of forming an image sent to the secondary transfer portion 130 at the same timing as the conveyance process of the sheet S to the secondary transfer portion 130 described above will be described. The image forming portion 140 mainly includes a photoconductor 141, an exposure device 142, a development device 143, and a primary transfer unit 144. The surface of the photoconductor 141 is uniformly charged in advance by a charging portion (not illustrated). The exposure device 142 emits light to the charged photoconductor 141 based on a signal of image information, and a latent image is formed via a diffraction unit or the like as appropriate. Toner development by the development device 143 is performed on the electrostatic latent image formed on the photoconductor 141 in this manner, and a toner image is formed on the photoconductor 141. The toner image formed on the photoconductor 141 is transferred onto the intermediate transfer belt 145 by a predetermined pressurizing force and electrostatic load bias applied by the primary transfer unit 144 at a primary transfer portion where the photoconductor 141 and the primary transfer unit 144 face each other.

In the case of the image forming apparatus illustrated in FIG. 1, the image forming portion 140 described above includes four sets of yellow Y, magenta M, cyan C, and black Bk. The image forming portions 140 of these four colors are arranged side by side on the intermediate transfer belt 145.

Next, the intermediate transfer belt 145 will be described. The intermediate transfer belt 145 is stretched around a plurality of rollers, and is conveyed and driven in an arrow direction in FIG. 1. Therefore, parallel processing is performed by the image forming portions 140 of yellow Y, magenta M, cyan C, and black Bk described above. The image forming process of each color is performed at a timing at which the primary transfer portion of each image forming portion 140 overlaps the upstream toner image primarily transferred onto the intermediate transfer belt 145. As a result, a full-color toner image is finally formed on the intermediate transfer belt 145 and conveyed to the secondary transfer portion 130.

The full-color toner image is secondarily transferred onto the sheet S in the secondary transfer portion 130 by the conveyance process and the image forming process of the sheet S described above. Thereafter, the sheet S is conveyed to a fixing device 150. The fixing device 150 fixes the toner image on the sheet S by applying a predetermined pressure by an opposing roller, belt, or the like and a heating effect by a heat source such as a heater in general.

The sheet S having the fixed image obtained in this manner is guided toward a first discharge roller 161 by a first switching flapper 151 at a position indicated by a solid line in FIG. 1, and is discharged onto a first stacking portion 171 by the first discharge roller 161. Alternatively, the sheet S is guided upward by the first switching flapper 151 switched to the broken line position in FIG. 1, and is conveyed toward a second discharge roller 162.

The sheet S conveyed toward the second discharge roller 162 is guided toward the second discharge roller 162 by a second switching flapper 152 at a position indicated by a broken line in FIG. 1, and is discharged onto a second stacking portion 172 disposed above the first stacking portion 171 by the second discharge roller 162.

In the case of duplex printing, the second discharge roller 162 is reversely rotated after the rear end of the sheet S passes through the second switching flapper 152. By the reverse operation of the second discharge roller 162, the sheet S is guided toward a re-feeding portion 180 by the second switching flapper 152 switched to the solid line position in FIG. 1. That is, in the case of duplex printing, the sheet S on which an image is formed by the image forming portion 140 is reversely conveyed by the reverse operation of the second discharge roller 162 and sent to the re-feeding portion 180, and is conveyed to the image forming portion 140 again by the re-feeding portion 180.

Then, the sheet S is conveyed to the image forming portion 140 (secondary transfer portion 130) by the registration roller pair 120 via the re-feeding portion 180, and an image is formed on the second surface similarly to the first surface. The duplex printed sheet S is discharged onto the first stacking portion 171 or the second stacking portion 172.

Note that the first stacking portion 171 and the second stacking portion 172 that stack the sheet S to be discharged have an upward slope from the upstream to the downstream in the discharge direction of the sheet S. Therefore, the discharged sheet S can be aligned to the upstream in the discharge direction by the weight of the sheet.

### (Opening and Closing Member)

The image forming apparatus 100 includes an opening and closing member 200 (broken line portion in FIG. 1) for performing maintenance such as jam recovery of a sheet remaining inside the apparatus and replacement of a unit by exposing the inside of the apparatus. The opening and closing member 200 is rotatably supported by the apparatus main body 101, and is opened and closed with respect to the apparatus main body 101 by being rotated. Specifically, the opening and closing member 200 is provided below the apparatus main body 101 so as to be rotatable about a shaft 201 in a direction of arrow b. The opening and closing member 200 can be opened toward the outside of the apparatus main body 101 from a closed position indicated by a broken line in FIG. 1 by unlocking the apparatus main body 101 with a handle (not illustrated) provided on the opening and closing member 200. On the other hand, the opened opening and closing member 200 is locked again by being pushed into the position indicated by the broken line in FIG. 1, and the apparatus main body becomes operable. By making the opening and closing member 200 openable and closable in this manner, it is possible to easily perform maintenance such as jam recovery and unit replacement by exposing the inside of the apparatus.

### (Opening Operation of Opening and Closing Member)

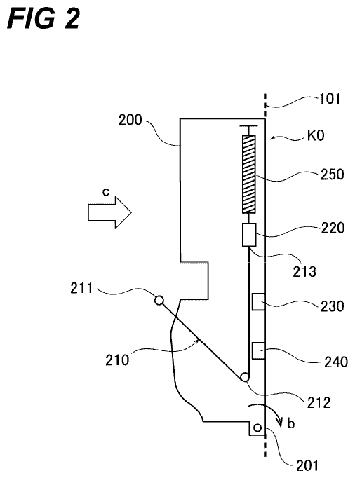

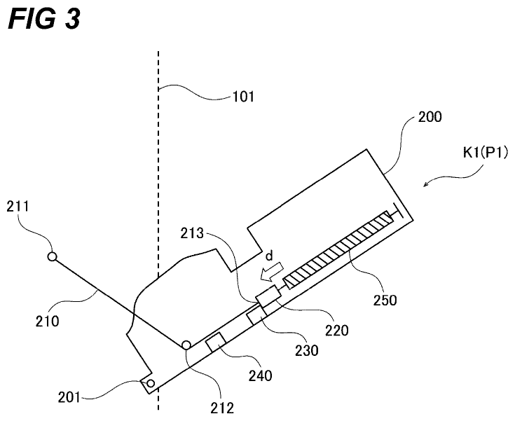

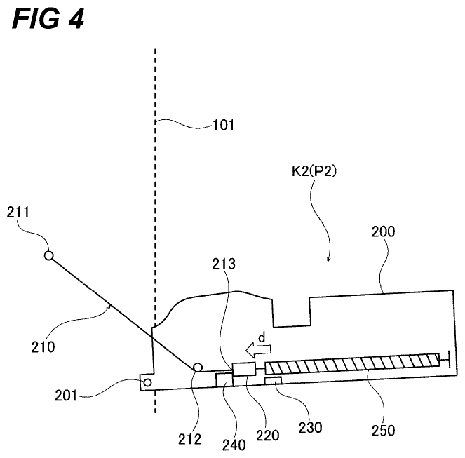

Here, the opening operation of the opening and closing member 200 of the image forming apparatus 100 will be described with reference to FIGS. 2, 3, and 4. FIG. 2 is a cross-sectional view when the opening and closing member 200 is at a closed position K0 with respect to the apparatus main body 101. FIG. 3 is a cross-sectional view when the opening and closing member 200 is at a first opening position K1 opened with respect to the apparatus main body 101. FIG. 4 is a cross-sectional view when the opening and closing member 200 is at a second opening position K2 opened with respect to the apparatus main body 101.

The opening and closing member 200 is connected to the apparatus main body 101 by a connecting member 210. One end portion of the connecting member 210 is supported by a main body connecting portion 211 of the apparatus main body 101, and a connecting portion 213 which is the other end portion of the connecting member 210 is connected to the opening and closing member 200. The connecting member 210 is suspended in a V shape by a folding portion 212 provided on the opening and closing member 200.

The connecting portion 213, which is the other end of the connecting member, is supported by one end of the support member 220. The other end of the support member 220 is connected to one end of a damper member 250. The other end of the damper member 250 is connected to the opening and closing member 200.

The damper member 250 is a biasing member that connects the opening and closing member 200 and the support member 220. As illustrated in FIGS. 3 and 4, the damper member 250 extends in a direction of arrow d and the biasing force increases in conjunction with the operation of opening the opening and closing member 200 in the direction of arrow b in FIG. 2.

In this manner, the apparatus main body 101 and the opening and closing member 200 are connected. With this configuration, when opening the opening and closing member 200, the weight of the opening and closing member 200 is relieved by the spring force of the damper member 250, and the opening position of the opening and closing member 200 is determined by the support member 220.

### (Support Member)

The opening position of the opening and closing member 200 is determined by the support member 220 abutting against a first restricting member 230 or a second restricting member 240. This will be described below.

As described above, the support member 220 has one end connected to the connecting member 210 and the other end connected to the damper member 250, and moves in the direction of arrow d in FIG. 3, which is the first direction, in conjunction with the operation of opening the opening and closing member 200 in the direction of arrow b in FIG. 2. The opening and closing member 200 includes a first restricting member 230 and a second restricting member 240 provided separately from the first restricting member 230.

As illustrated in FIG. 3, when the opening and closing member 200 starts to be opened in the direction of arrow b illustrated in FIG. 2, the support member 220 gradually moves in the direction of arrow d by extension of the damper member 250. That is, the support member 220 moves in the direction of arrow d in conjunction with the opening operation of the opening and closing member 200. Eventually, the support member 220 abuts against the first restricting member 230 at the first restricting position P1, and the movement in the direction of arrow d is restricted and stops. In other words, the first restricting member 230 comes into contact with the support member 220 that moves in the direction of arrow d in conjunction with the opening operation of the opening and closing member 200, and restricts the movement of the support member 220 in the direction of arrow d. As a result, the opening and closing member 200 can be maintained at the first opening position K1 illustrated in FIG. 3. That is, the opening and closing member 200 is maintained at the first opening position K1 where the jam recovery is performed by the support member 220 coming into contact with the first restricting member 230 to restrict the movement.

Here, the first restricting member 230 can be released from abutting on the support member 220 by a switching member 260 to be described below. As illustrated in FIG. 4, the support member 220 released from the abutment further moves in the direction of arrow d as the opening and closing member 200 is further opened in the direction of arrow b illustrated in FIG. 2. Eventually, the support member 220 abuts against the second restricting member 240, and the movement in the direction of arrow d is restricted and stops.

The second restricting member 240 is provided on the downstream of the first restricting member 230 in the direction of arrow b which is the moving direction of the support member 220. The second restricting member 240 comes into contact with the support member 220 at the second restricting position P2 on the downstream of the first restricting position P1 by the first restricting member 230 to restrict the movement of the support member 220 in the direction of arrow d. As a result, the opening and closing member 200 can be maintained at the second opening position K2 illustrated in FIG. 4, which is wider than the first opening position K1 illustrated in FIG. 3.

That is, the support member 220 comes into contact with the second restricting member 240 to restrict the movement of the opening and closing member 200, so that the opening and closing member is maintained at the second opening position K2 where maintenance such as unit replacement is performed.

As described above, the opening position of the opening and closing member 200 is determined by the support member 220 abutting against the first restricting member 230 or the second restricting member 240.

### (Switching Member)

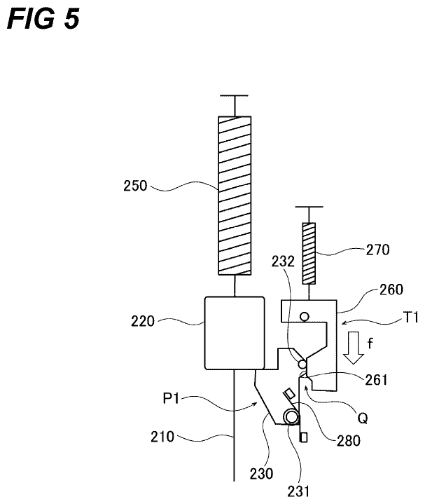

Next, with reference to FIGS. 5 to 8, a switching member 260 that switches restriction or restriction release of the support member 220 by the first restricting member 230 in order to open the opening and closing member 200 from the first opening position K1 to the second opening position K2 will be described. FIGS. 5 to 8 are views illustrating a state in which the support member 220 starts to move from the first restricting position P1 to the second restricting position P2 in the switching member 260 in time series.

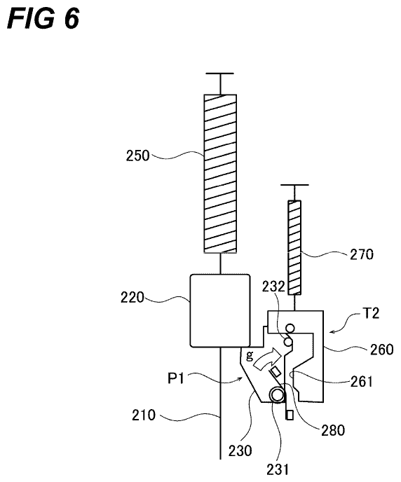

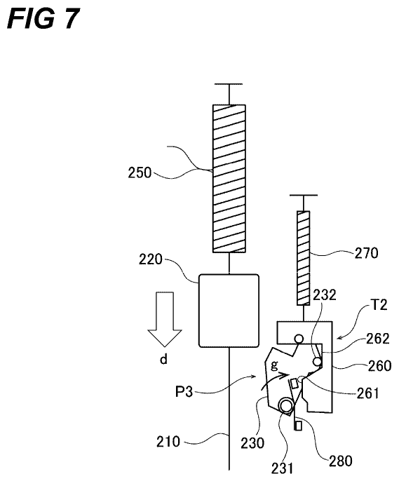

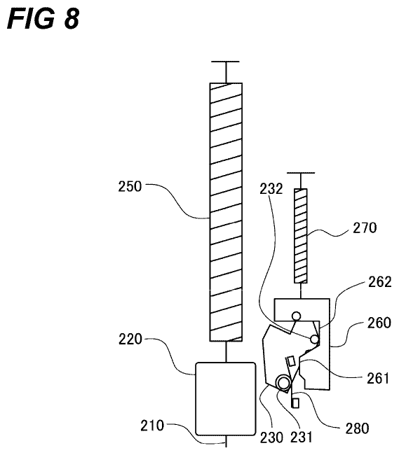

FIG. 5 is a view of a state in which the support member 220 is supported at the first restricting position P1. FIG. 6 is a view illustrating a state in which the switching member 260 is switched from the support position (first restricting position P1) toward the release position. FIG. 7 is a view illustrating a state in which the first restricting member 230 is retracted from the first restricting position P1 to the retracted position P3. FIG. 8 is a view illustrating a state in which the support member 220 moves from the first restricting position P1 toward the second restricting position P2.

As described above, the movement of the support member 220 in the direction of arrow d is restricted by abutting against the first restricting member 230, and is maintained at the first opening position K1 illustrated in FIG. 3. The first restricting member 230 is provided so as to be movable to the first restricting position P1 in FIG. 5 where the first restricting member 230 comes into contact with the support member 220 to restrict the movement of the support member 220 in the direction of arrow d and a retracted position P3 in FIG. 7 where the first restricting member 230 is retracted from the first restricting position P1 to allow the movement of the support member 220 in the direction of arrow d. Here, the first restricting member 230 is rotatably supported by the opening and closing member 200 about the shaft 231, and moves to the first restricting position P1 and the retracted position P3 by rotating about the shaft 231.

The opening and closing member 200 includes the switching member 260 that switches the position of the first restricting member 230. The switching member 260 is switched between a support position T1 in FIG. 5 in which the switching member 260 comes into contact with the first restricting member 230 to support the first restricting member 230 at the first restricting position P1 and a release position T2 in FIG. 7 in which the switching member releases the contact by moving in a direction of arrow f illustrated in FIG. 5 to allow the movement of the first restricting member 230 to the retracted position P3.

Here, the switching member 260 is movably supported by the opening and closing member 200, and is linearly movably supported in the direction of arrow f in FIG. 5 or a direction opposite to the direction of arrow f. The switching member 260 switches whether or not the first restricting member 230 can move by moving linearly. Note that the direction of arrow f in FIG. 5, which is the moving direction of the switching member 260, is a direction along the direction of arrow d in FIG. 3, which is the moving direction (first direction) of the support member 220, and can be said to be the same direction.

The first restricting member 230 is applied a force by a biasing spring 280 in a direction in which an abutting portion 232 of the first restricting member 230 abuts against a support portion 261 of the switching member 260 at the support position T1 in FIG. 5. That is, the first restricting member 230 is applied a force in a direction from the first restricting position P1 to the retracted position P3 by the biasing spring 280. Therefore, the first restricting member 230 is supported by the switching member 260 at the support position T1 in FIG. 5 from a state before the support member 220 abuts against the first restricting member 230, and stands by at the first restricting position P1 where the support member 220 can abut.

A restoring force in a direction opposite to the direction of arrow fin FIG. 5 is applied to the switching member 260 by a tension spring 270 having one end supported by the opening and closing member 200 and the other end supported by the switching member 260. In order to maintain the first restricting member 230 at the first restricting position P1, the switching member 260 is applied a force by the tension spring 270 and abuts against the opening and closing member 200 to be maintained at the support position T1 in FIG. 5.

In order to move the support member 220 from the first restricting position P1 of the first restricting member 230 to the second restricting position P2 of the second restricting member 240, first, the switching member 260 is moved in the direction of arrow fin FIG. 5 to switch from the support position T1 in FIG. 5 to the release position T2 in FIG. 6. Then, since the abutment between the abutting portion 232 of the first restricting member 230 and the support portion 261 of the switching member 260 is released, the first restricting member 230 tends to rotate in the direction of arrow g in FIG. 6 by the biasing spring 280. However, the support member 220 still abuts on the first restricting member 230, and the rotation trajectory of the first restricting member 230 is blocked. Therefore, the first restricting member 230 cannot rotate and is maintained at the first restricting position P1.

At this time, when the opening and closing member 200 is slightly rotated in a closing direction (a direction opposite to the direction of arrow b in FIG. 2), the support member 220 moves in a direction away from the first restricting member 230. Therefore, as illustrated in FIG. 7, the first restricting member 230 rotates in the direction of arrow g by the biasing spring 280, and the first restricting member 230 moves to a position where the abutting portion 232 abuts against a retraction portion 262 of the switching member 260. In other words, the first restricting member 230 is moved from the first restricting position P1 in FIG. 5 to the retracted position P3 in FIG. 6 by the biasing spring 280.

Thus, the support member 220 is not restricted at the first restricting position P1, and the support member 220 can move in the direction of arrow d. Then, when the opening and closing member 200 is further opened from this state, the support member 220 eventually abuts against the second restricting member 240, the movement in the direction of arrow d is restricted, and the support member 220 stops at the second restricting position P2.

As described above, the switching member 260 enables the opening of the opening and closing member 200 to the second opening position (second restricting position P2) from the state in which the opening and closing member 200 is supported at the first opening position (first restricting position P1).

Here, the direction of the force applied to the switching member 260 by the first restricting member 230 at the first restricting position P1 is a direction substantially perpendicular to the moving direction of the switching member 260 in the switching operation. In other words, at a contact portion Q with the switching member 260 when the first restricting member 230 is at the first restricting position P1, the moving direction (direction of arrow g) of the first restricting member 230 and the moving direction (direction of arrow f) of the switching member 260 intersect (substantially orthogonal) with each other. The direction in which the first restricting member 230 is rotated by the abutted support member 220 is a direction in which the first restricting member 230 is separated from the switching member 260. That is, since the load due to the weight of the opening and closing member 200 is not applied to the switching member 260, the load does not substantially affect the switching operation of the switching member.

Therefore, when the operator releases the opening member from the first opening position K1 (first restricting position P1) to the second opening position (second restricting position P2), the switching member 260 can be easily operated, and the opening and closing member 200 can be operated after the operation of the switching member 260 is completed. Therefore, a large force is not required for the switching operation, and it is not necessary to simultaneously perform two operations (different operations), and operability for the operator is improved.

### (Operation Member)

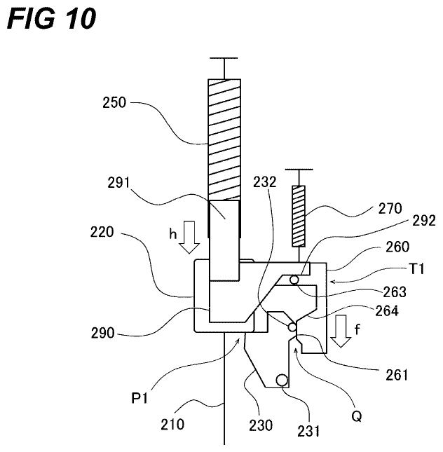

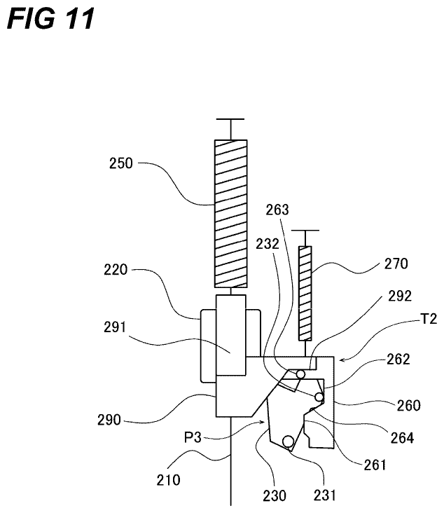

The switching member 260 is provided inside the opening and closing member 200. Therefore, an operation member 290 operated by the operator to switch the position of the switching member 260 is provided. The operation member 290 will be described with reference to FIGS. 9 to 11. FIG. 9 is a view of the opening and closing member 200 as viewed from a direction of arrow c in FIG. 2. FIGS. 10 and 11 are views in which an operation member 290 is added to the switching member 260. FIG. 10 is a diagram before the switching operation of the switching member, and FIG. 11 is a diagram after the switching operation of the switching member.

The opening and closing member 200 includes a conveying roller that conveys the recording material and a guide member that guides the recording material. For example, as illustrated in FIG. 9, the opening and closing member 200 includes, as the conveying roller, one registration roller 122 of the registration roller pair 120, one secondary transfer outer roller 132 of the secondary transfer portion 130, and the like. In addition, the opening and closing member 200 includes, as a guide member, a conveyance guide 190 provided between the sheet feeding portion 110 and the fixing device 150. Therefore, by opening the opening and closing member 200 with respect to the apparatus main body 101, one conveyance guide and one conveying roller facing each other via the sheet in the sheet conveyance path inside the apparatus main body are separated from the other conveyance guide and the other conveying roller. This facilitates recovery of the sheet stopped due to the jam. In addition, maintenance such as unit replacement can be easily performed.

The operation member 290 that switches the position of the switching member 260 includes the operation portion 291 operated by the operator and the abutting portion 292 against which the switching member 260 applied a force in the direction opposite to the direction of arrow d by the tension spring 270 is abutted at the support position T1. The operation member 290 is provided inside the opening and closing member 200. The operation portion 291 of the operation member 290 is provided outside the opening and closing member 200 so as to be exposed to the outside by opening the opening and closing member 200 with respect to the apparatus main body 101. In other words, in the operation member 290, the operation portion 291 is exposed to the outside of the opening and closing member 200 so that the operation portion 291 can be operated from the outside of the opening and closing member 200, and the other portions are covered by a cover and provided inside the opening and closing member 200.

The operation portion 291 of the operation member 290 is provided on a surface of the opening and closing member 200 on a side facing the inside of the apparatus main body. The operation portion 291 of the operation member 290 is provided at a central portion on one side (here, the rear side of the image forming apparatus) in a width direction (front-back direction) orthogonal to a sheet conveyance direction (up-down direction) outside a sheet conveyance region.

The operation member 290 is provided so as to be in contact with the operation portion 263 of the switching member 260 at the support position T1 by the abutting portion 292. The operation member 290 is provided on the opening and closing member 200 so as to be movable in the direction of arrow h, and the switching member 260 is configured to be moved in the direction of arrow f in conjunction with this movement. Note that the direction of arrow h in FIG. 10, which is the movement direction of the operation member 290, is a direction along the direction of arrow fin FIG. 5, which is the movement direction of the switching member 260, and the direction of arrow d in FIG. 3, which is the movement direction (first direction) of the support member 220, and can be said to be the same direction.

When the operator operates the operation member 290 in the direction of arrow h in FIG. 10 at the first restricting position P1, the operation portion 263 coming into contact with the abutting portion 292 moves in conjunction with the same direction, and the switching member 260 moves in the direction of arrow f. Then, the switching member 260 is switched to the release position T2 as described with reference to FIGS. 5 to 8, the first restricting member 230 is further moved to the retracted position P3, the movement restriction of the support member 220 is released, and the support member 220 becomes movable from the first restricting position P1 to the second restricting position P2. As a result, the opening and closing member 200 can rotate from the first opening position K1 to the second opening position K2.

When the operation member 290 moves in the direction of arrow h and moves the switching member 260 to the release position T2, the operation member 290 tries to return by the return force of the tension spring 270, but is locked so as not to be movable by being engaged with the opening and closing member 200. As a result, the operation member 290 locked so as not to be movable maintains the switching member 260 at the release position T2 by the contact between the abutting portion 292 and the operation portion 263. Further, the operation member 290 is disengaged and movable by the support member 220 that is moved in the direction opposite to the direction of arrow h along with the operation of closing the opening and closing member 200. That is, the engagement (locked state) of the operation member 290 is released by the support member 220 moved with the operation of closing the opening and closing member 200 at the timing when the support member 220 passes the first restricting position P1.

The operation member 290 released from the engagement is moved in the same direction in conjunction with the movement of the switching member 260 in the opposite direction by the tension spring 270, and restricts the switching member 260 at the support position T1. Here, the switching member 260 includes a guide portion 264 between the support portion 261 and the retraction portion 262. When the switching member 260 moves in the opposite direction, the guide portion 264 of the switching member 260 comes into contact with the abutting portion 232 of the first restricting member 230 to move the first restricting member 230 from the retracted position P3 to the first restricting position P1. Further, the first restricting member 230 moved to the first restricting position P1 returns to a state where the abutting portion 232 abuts on the support portion 261 of the switching member 260 and is supported by the support portion 261 of the switching member 260 at the first restricting position P1, and being restricted at the first restricting position P1.

Therefore, when the opening and closing member 200 is opened again, the first restricting member 230 returns to the state of being restricted to the first restricting position P1 by the switching member 260. Therefore, in order to open the opening and closing member 200 again from the first opening position K1 (first restricting position P1) to the second opening position K2 (second restricting position P2), it is necessary to operate the operation member 290 again. With this configuration, it is possible to prevent the opening and closing member 200 from being unintentionally and erroneously opened to the second opening position K2 (second restricting position P2). In addition, since the switching member 260 (and the operation member 290) automatically returns to the restricting position in conjunction with the operation of closing the opening and closing member 200, it is not necessary to manually operate the operation member 290 so as to be restricted to the first restricting position P1. In addition, it is possible to prevent forgetting to return the switching member 260 (and the operation member 290).

### (Other Support Members)

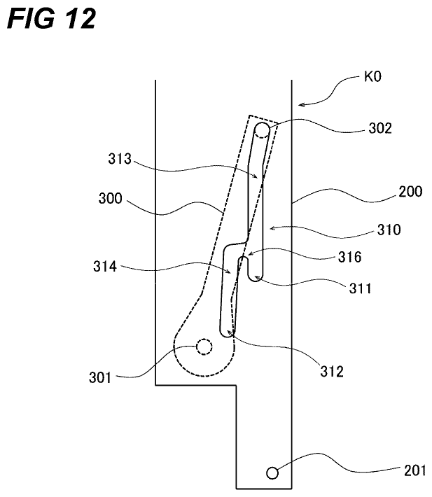

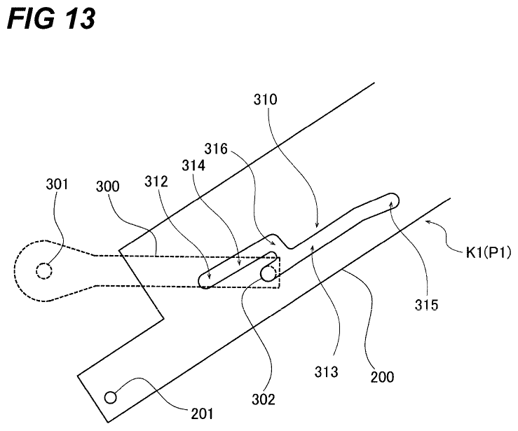

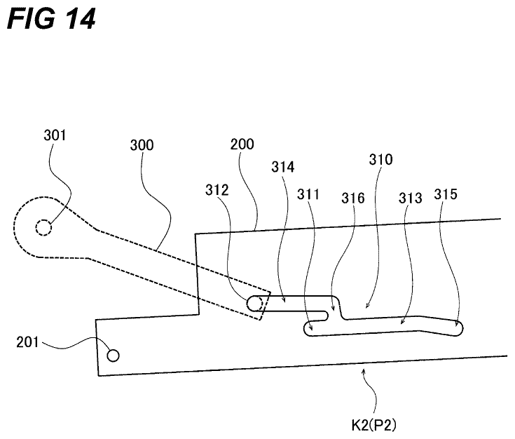

Although the configurations of the opening and closing member 200, the support member 220 provided on the rear side of the apparatus main body, the switching member 260, and the like have been described so far, the opening and closing member 200 is also provided with a front support member 300, which is another support member (second support member), on the front side of the apparatus main body. The front support member 300 will be described with reference to FIGS. 12, 13, and 14. FIG. 12 is a view of the front support member 300 when the opening and closing member 200 is at a closed position K0 with respect to the apparatus main body. FIG. 13 is a view of the support member 220 when the opening and closing member 200 is at the first opening position K1 (first restricting position P1) with respect to the apparatus main body. FIG. 14 is a view of the front support member 300 when the opening and closing member 200 is at the second opening position K2 (second restricting position P2) with respect to the apparatus main body.

One end portion of the front support member 300 is rotatably supported by the apparatus main body by the shaft 301, and the other end portion is supported by the opening and closing member 200 by a guided portion 302. The front support member 300 is guided along a guide groove 310 provided in the opening and closing member 200 by the guided portion 302. The guide groove 310 guides the guided portion 302 of the opening and closing member 200 by an operation of opening and closing the opening and closing member 200.

The guide groove 310 includes a first guide groove 313 and a second guide groove 314 provided to branch from the first guide groove 313.

The first guide groove 313 guides the guided portion 302 of the opening and closing member 200 by an operation of opening the opening and closing member 200 from the closed position K0. The first guide groove 313 has a first support portion 311 that restricts the operation of opening the opening and closing member 200 by supporting the guided portion 302 and maintains the opening and closing member 200 at the first opening position K1 (first restricting position P1).

The second guide groove 314 guides the guided portion 302 of the opening and closing member 200 by an operation of opening the opening and closing member 200 from the first opening position K1. The second guide groove 314 has a second support portion 312 that restricts the operation of opening the opening and closing member 200 by supporting the guided portion 302 and maintains the opening and closing member 200 at a second opening position K2 (second restricting position P2) wider than the first opening position K1.

When the opening and closing member 200 is released from the closed position K0 with respect to the apparatus main body, the guided portion 302 moves from the operating position 315 of the guide groove 310 to the first support portion 311 through the first guide groove 313. At this time, the guided portion 302 maintains the state in which the opening and closing member 200 is at the first opening position K1 (first restricting position P1) by restricting the opening and closing member 200 from being opened by the first support portion 311.

In order for the guided portion 302 to move from the first support portion 311 to the second support portion 312, the opening and closing member 200 is slightly rotated in a closing direction, and the guided portion 302 is guided to pass through a branch portion 316, so that the guided portion 302 moves through the second guide groove 314 and moves to the second support portion 312. At this time, similarly to the first support portion 311, the guided portion 302 maintains the state in which the opening and closing member 200 is at the second opening position K2 (second restricting position P2) by restricting the opening and closing member 200 from being opened by the second support portion 312.

When the opening and closing member 200 is rotated from the second restricting position P2 to the state where the opening and closing member is closed in the apparatus main body, the guided portion 302 moves from the second guide groove 314 to the operating position 315 through the branch portion 316. As described above, on the front side of the apparatus main body of the opening and closing member 200, the opening and closing member 200 is supported at the first opening position K1 (first restricting position P1) and the second opening position K2 (second restricting position P2) by the front support member 300.

As described above, according to the present embodiment, the load applied to the first restricting member 230 from the support member 220 at the first restricting position P1 does not act on the operating force of the switching member 260. As a result, when the opening position of the opening and closing member 200 is switched, a load due to the weight of the opening and closing member 200 is not applied to the switching member 260, so that the switching member 260 can be easily operated. Therefore, it is not necessary to simultaneously perform two operations, and operability is improved.

The first restricting position P1 and the second restricting position P2 are opening positions of the opening and closing member 200 for jam recovery, maintenance of the apparatus main body, unit replacement, and the like, but the purpose of defining the respective positions is not limited thereto. Although the first restricting member 230 has been described to be configured to rotate, it may be configured to move linearly. Although a spring is used as the damper member 250 for relieving the weight of the opening and closing member 200, the damper member is not limited to a spring.

In the present embodiment, the connecting member 210, the support member 220, the damper member 250, the first restricting member 230, the second restricting member 240, the folding portion 212, the switching member 260, and the like are provided only on one side surface (the rear side of the apparatus main body) in the opening and closing member 200, but the present invention is not limited thereto. That is, for example, as a configuration in which the above-described members are provided on both side surfaces (the front side and the rear side of the apparatus main body) of the opening and closing member 200 or a configuration in which the above-described members are provided in portions other than the side surfaces, the opening position of the opening and closing member 200 may be switched only by the above-described members.

In the present embodiment, the support member 220 that supports the connecting member 210 is configured to be movable on the opening and closing member side, but the present invention is not limited thereto. That is, even if the support member 220 that supports the connecting member 210 is configured to be movable on the image forming apparatus main body side, and the same configuration as the above-described member provided on the opening and closing member side is provided on the image forming apparatus main body side, the same effects as described above can be obtained.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-065340, filed Apr. 15, 2024, which is hereby incorporated by reference herein in its entirety.

What is claimed is:

1. An image forming apparatus comprising:
an opening and closing member rotatably supported by an image forming apparatus main body and configured to open and close with respect to the image forming apparatus main body by being rotated;
a connecting member having one end portion supported by the image forming apparatus main body and the other end portion supported by the opening and closing member;
a support member configured to support the other end portion of the connecting member, the support member being configured to move in a first direction in conjunction with an operation of opening the opening and closing member;
a restricting member configured to be movable to a restricting position at which the restricting member is brought into contact with the support member to restrict movement of the support member in the first direction and a retracted position at which the support member is retracted from the restricting position to allow movement of the support member in the first direction, the restricting member being configured to restrict movement of the support member in the first direction to maintain the opening and closing member at an opening position; and
a switching member configured to be switched between a support position where the switching member is brought into contact with the restricting member to support the restricting member at the restricting position, and a release position where the switching member releases the contact with the restricting member to allow the movement of the restricting member to the retracted position.

2. The image forming apparatus according to claim 1, wherein the switching member moves from the support position to the release position by moving in a direction along the first direction.

3. The image forming apparatus according to claim 1, further comprising a biasing member that connects the opening and closing member and the support member,
wherein the biasing member increases a biasing force in conjunction with an operation of opening the opening and closing member.

4. The image forming apparatus according to claim 1, further comprising a second restricting member, with the restricting member as a first restricting member, being provided separately from the first restricting member,
wherein the second restricting member comes into contact with the support member at a second restricting position downstream of the restricting position in the first direction, and restricts movement of the support member in the first direction to maintain the opening and closing member at a second opening position wider than the opening position.

5. The image forming apparatus according to claim 1, wherein the restricting member is rotatably supported by the opening and closing member, and moves to the restricting position and the retracted position by being rotated.

6. The image forming apparatus according to claim 1, wherein the switching member is supported so as to be linearly movable in the first direction or a direction opposite to the first direction, and the switching member is linearly moved to switch whether the restricting member is movable or not.

7. The image forming apparatus according to claim 1, wherein a moving direction of the restricting member and a moving direction of the switching member intersect each other at a contact portion with the switching member when the restricting member is at the restricting position.

8. The image forming apparatus according to claim 1, further comprising a biasing spring configured to apply a force to the restricting member in a direction from the restricting position toward the retracted position.

9. The image forming apparatus according to claim 1, wherein the switching member includes: a support portion that comes into contact with the restricting member to support the restricting member at the restricting position; and a guide portion that comes into contact with the restricting member when the switching member moves in a direction opposite to the first direction to guide the restricting member from the retracted position to the restricting position.

10. The image forming apparatus according to claim 1, wherein the opening and closing member includes: a conveying roller that conveys a recording material; and a guide member that guides the recording material.

11. The image forming apparatus according to claim 1, further comprising:
an operation member that is provided on the opening and closing member so as to be movable in the first direction and switches a position of the switching member,
wherein the operation member is engaged with the opening and closing member to be locked so as not to be movable when the switching member is moved to the release position, and the operation member is disengaged from the opening and closing member by the support member moved in a direction opposite to the first direction along with an operation of closing the opening and closing member so as to be movable.

12. The image forming apparatus according to claim 1, further comprising:
a second support member having one end rotatably supported by the image forming apparatus main body and the other end supported by the opening and closing member; and
a guide groove provided in the opening and closing member and configured to guide the other end of the opening and closing member by an operation of opening and closing the opening and closing member,
wherein the guide groove includes: a first guide groove configured to guide the other end of the opening and closing member by an operation of opening the opening and closing member from a closed position, the first guide groove including a first support portion configured to restrict the operation of opening the opening and closing member by supporting the other end and maintain the opening and closing member at a first opening position; and
a second guide groove configured to branch from the first guide groove and configured to guide the other end of the opening and closing member by an operation of opening the opening and closing member from the first opening position, the second guide groove including a second support portion configured to restrict the operation of opening the opening and closing member by supporting the other end and maintain the opening and closing member at a second opening position wider than the first opening position.
